(19) United States
(12) Patent Application Publication
(10) Pub. No.: US 2013/0093889 A1
(43) Pub. Date: Apr. 18, 2013

(54) SMART REAR-VIEW DISPLAY

(71) Applicant: Continental Automotive Systems, Inc., Auburn Hills, MI (US)

(72) Inventors: Philip Mark Headley, Brighton, MI (US); Jeffery Robert Skvarce, Clarkston, MI (US)

(73) Assignee: CONTINENTAL AUTOMOTIVE SYSTEMS, INC., Auburn Hills, MI (US)

(21) Appl. No.: 13/624,213

(22) Filed: Sep. 21, 2012

Related U.S. Application Data
(60) Provisional application No. 61/547,322, filed on Oct. 14, 2011.

(51) Int. Cl. H04N 7/18

(52) U.S. Cl. 348/148; 348/E07.085

(57) ABSTRACT

A display system for a vehicle comprises a display mounted within a passenger compartment of a vehicle and at least one camera mounted to the vehicle and facing at least partially in a rear direction. The display shows the images recorded by the camera(s) to provide a rear view for the driver of the vehicle. An ECU for the display system analyzes the images to provide additional information. The ECU controls the camera viewing angle as well to provide wide-angle images, and to pan or zoom the camera(s).

### PRIORITY

This application is a non-provisional of, and claims priority to the Oct. 14, 2011, filing date of, U.S. provisional patent application Ser. No. 61/547,322, the entire content of which is incorporated herein by reference.

### TECHNICAL FIELD

The present disclosure relates to automotive vehicles, and more particularly to driver assistance devices for automotive vehicles.

### BACKGROUND

Rear view mirrors are used to assist a driver in backing up a vehicle and to view vehicles located behind them. Rear view mirrors are typically secured to the top-center of the windshield area for convenience of the driver. However, the mirror may be partially or fully obstructed by window pillars, passengers, luggage, headrests, video monitors or other objects located in the passenger compartment of the vehicle. Additionally, objects such as bike or tire racks may block the rear window of the vehicle also partially or fully obstructing the rear view mirror.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A display system for a vehicle comprises a display mounted within a passenger compartment of a vehicle and at least one camera mounted to the vehicle and facing at least partially in a rear direction. The display shows the images recorded by the camera(s) to provide a rear view for the driver. An ECU for the display system analyzes the images to provide additional information. The ECU controls the camera viewing angle as well to provide wide-angle images, and to pan or zoom the camera(s).

A method for providing a rear view image for a vehicle comprises recording a rear view of the vehicle with at least one camera that is at least partially facing in a rear direction. An unobstructed image of a rear view from the vehicle is provided on a display screen, such that the image is visible to a driver of the vehicle. The at least one camera is controlled with the ECU to change the image displayed on the display screen.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle utilizing a rear view display of the present invention;

FIG. 2 is a schematic illustration of a first embodiment of the rear view display for the vehicle of FIG. 1;

FIG. 3 is a schematic illustration of a first feature of the rear view display for the vehicle of FIGS. 1-2;

FIG. 4 is a schematic illustration of a second feature of the rear view display for the vehicle of FIGS. 1-3;

FIG. 5 is a schematic illustration of a second embodiment of the rear view display for the vehicle of FIG. 1 during a right turn; and

FIG. 6 is a schematic illustration of the second embodiment of the rear view display for the vehicle of FIGS. 1 and 5 during a left turn.

### DETAILED DESCRIPTION

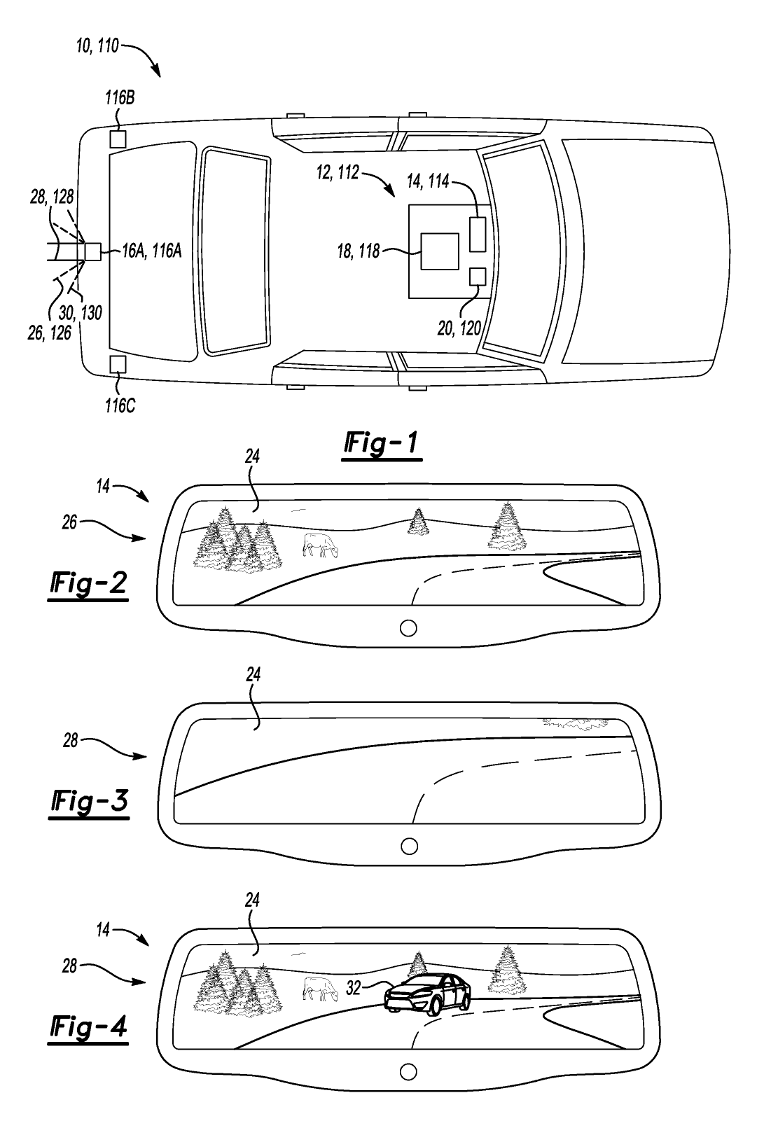

The following description is merely exemplary in nature and is in no way intended to limit the disclosure, its application, or uses. For purposes of clarity, the same reference numbers will be used in the drawings to identify similar elements. FIGS. 1 and 2 illustrate a first embodiment of a vehicle 10 and a rear view display system 12 of the present invention. Throughout the application the relative directions such as forward and rear are in reference to the direction which a driver for the vehicle 10 would primarily be facing when operating the vehicle 10. The rear view display system 12 includes a display screen 14 mounted to the vehicle 10 in an easily accessible location for a driver to observe. The display screen 14 may be mounted in the traditional rear-view mirror position, proximate to the upper center of the windshield. Other mounting positions for the display screen 14 may also be considered. The display screen 14 is connected to at least one camera 16A mounted to the rear of the vehicle 10. The camera(s) 16A may also be a wide-angle camera(s), such that a larger area may be viewed.

The camera(s) 16A and the display screen 14 are connected to an ECU 18 which controls the display screen 14 and the camera(s) 16A. The display screen 14 may be set to primarily show the image from the camera(s) 16A. However, the display system 12 may include a feature to also provide additional information to the driver about the rear view of the vehicle 10. For example, the driver may be able to select a view to zoom or pan the camera(s) 16A and to adjust the camera(s) 16A position to changes views, etc. For example, the driver may be able to select between a normal view and several varying widths of panoramic angles to be shown on the display screen 14. FIG. 2 illustrates an image 24 for a normal viewing mode 26 for the display screen 14. FIG. 3 illustrates an image 24 for a close-in view when the camera(s) 16A is zoomed for a close-in viewing mode 28. The ECU 18 controls the image 24 on the display screen 14 as well as the position of the camera(s) 16A. Because the rear view image 24 provided to the driver is supplied by the camera(s) 16A objects within the passenger compartment will not obstruct the view.

Although, the image 24 shown may change, the display screen 14 continuously shows an image 24 when the vehicle 10 is running, regardless of the drive gear of the vehicle 10. That is, the display screen 14 displays an image 24 that shows at least a partial rear view of the vehicle 10 whether the vehicle 10 is in a forward or reverse drive gear. The display screen 14 may also show at least a partial rear view image while the vehicle 10 is in park as well. The image 24 displayed may change views, such as from one camera 16A to another or by panning a camera 16A. However, continuously showing an image 24 is showing at least a partial rear view of the vehicle 10 on the display screen 14 while the vehicle 10 is in a drive gear. Thus, the display system 14 can be used in place of a rear view mirror.

Additional information may also be provided by the rear view display system 12 for the driver of the vehicle 10. The display screen 14 can be controlled by the ECU 18 to provide the additional information. For example, the ECU 18 may adjust the image 24 on the display screen 14 to dim only selected portions of the display screen 14, such as for headlights captured by the camera(s) 16A, or to automatically switch the display to a “blind spot” image upon initiation of a turn signal. For example, the view may automatically switch to a panoramic or wide-angle view mode 30 when a turn indicator is used. The view on the display screen 14 may return to the previously displayed view mode 26 or 28 after completion of the turn or after a predetermined amount of time.

The ECU 18 may also serve to highlight features or objects 32 on the display screen 14 as well. For example, emergency vehicles, motorcycles that may be difficult to see, or a missed turn, if a navigation system has been programmed. FIG. 4 illustrates one manner of highlighting a feature or object 32 on the display screen 14. Highlighting a feature or object 32 may be accomplished by brightening that portion of the display or circling or outlining the object in a highlighting color.

The ECU 18 may also change the display on the display screen 14 at the request of the driver. Controls for selecting between the different viewing modes 26, 28, 30 may be located on the steering wheel or instrument panel at a convenient location for the driver. The driver may select default settings for the ECU 18 to control the display screen 14 so that the display screen 14 operates in the desired manner while the vehicle 10 is moving without requiring input from the driver of the vehicle 10. A default display mode 26, 28, 30 for the display screen 14 may also be chosen such that alternate display modes 26, 28, 30 will return to the default display mode 26, 28, 30 after a predetermined period of time.

Rear view mirrors are easily adjustable because the reflection perceived by a driver in a rear view mirror depends highly on the position of the mirror relative to the driver's head. Because a camera(s) 16A is used there is an image on the display screen 14 rather than a reflection in a mirror. Thus, the need for the driver to adjust the display screen 14 to obtain the proper mirror position for seeing the rear view of the vehicle 10 may be reduced or eliminated. However, the position of the display screen 14 may still be adjustable to enhance the individual driver's view of the display screen 14. In one embodiment the ECU 18 may recognize the desired display system 12 settings and position for an individual driver and adjust the display screen 14 and camera(s) 16A viewing mode 26, 28, 30 accordingly.

The camera(s) 16A may also be used by other vehicle 10 systems, such as vehicle 10 backing systems, park assist, and for providing top views of the vehicle 10. Additional features 20 such as sensors or cameras for other systems may be connected to the ECU 18 as well to send information that may be displayed or used to display the image 24 on the display screen 14. The additional features may also include controls for driver adjustment of the camera(s) 16A, the display screen 14 and the images shown thereon.

FIGS. 1, 5 and 6 illustrate a second embodiment of a vehicle 110 and a rear view display system 112 of the present invention. The rear view display system includes a display screen 114 mounted to the vehicle 110 in an easily accessible location for a driver to observe. The display screen 114 may be mounted in the traditional rear-view mirror position, proximate to the upper center of the windshield. Other mounting positions for the display screen 114 may also be considered. The display screen 114 is connected to at least one camera 116A mounted to the rear of the vehicle 110. Multiple cameras 116A-C may be mounted to the vehicle 110 to provide viewing of different area surrounding the vehicle 110. For example, cameras 116A-C may be mounted to capture the “blind spot” area that is typically not shown by rear view mirrors and driver positioning. The camera 116A-C may also be wide-angle cameras, such that are larger area may be viewed.

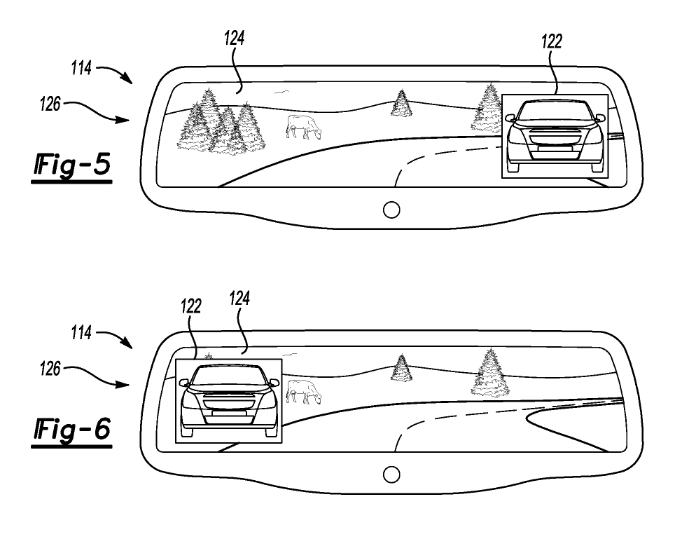

The camera 116A-C and the display screen 114 are connected to an ECU 118 which controls the display screen 114 and the cameras 116A-C. The display screen 114 may be set to primarily show the image from one camera 116A. However, the display system 112 may include a feature to also provide additional information to the driver about the rear view of the vehicle 110. For example, the driver may be able to select a view to show the other cameras 116B-C, to zoom or pan the camera and to adjust the cameras 116A-C positions to change views, etc. The driver may also be able to select between a normal view and several varying widths of panoramic angles to be shown on the display screen 114. FIG. 5 illustrates an image 124 for a normal viewing mode 126 for the display screen 114. A close-in view mode 128 or a wide-angle/panoramic view mode 130 may also be available.

The ECU 118 controls the image on the display screen 114 as well as the position of the camera 116A-C. Because the rear view image provided to the driver is supplied by the camera 116A-C objects within the passenger compartment will not obstruct the view.

Although, the image 124 shown may change, the display screen 114 continuously shows an image 124 when the vehicle 110 is running, regardless of the drive gear of the vehicle 110. That is, the display screen 114 displays an image 124 that shows at least a partial rear view of the vehicle 110 whether the vehicle 110 is in a forward or reverse drive gear. The display screen 114 may also show at least a partial rear view image while the vehicle 110 is in park as well. The image 124 displayed may change views, such as from one camera to another or by panning a camera. However, continuously showing an image 124 is showing at least a partial rear view of the vehicle 110 on the display screen 114 while the vehicle 110 is in a drive gear. Thus, the display system 114 can be used in place of a rear view mirror.

Additional information may also be provided by the rear view display system 112 for the driver of the vehicle 110. The display screen 114 can be controlled by the ECU 118 to provide the additional information. For example, the ECU 118 may adjust the image 124 on the display screen 114 to dim only selected portions of the display screen 114, such as for headlights captured by the camera(s) 116A, or to automatically switch the display to a “blind spot” image upon initiation of a turn signal. In FIG. 5, the display screen 114 is selected to show the view 124 from a rear center mounted camera 116A, if the right turn indicator is used an inset area 122 on the display screen 124 may shown the view from a rear right mounted camera 116C to display the “blind spot” to the driver. In FIG. 6, the display screen 114 is selected to show the view from a rear center mounted camera 116A, if the left turn indicator is used a inset area 122 on the screen may shown the view from a rear left mounted camera 116B to display the “blind spot” to the driver.

The inset area 122 may be displayed on the same side of the display screen 114 as the view from the vehicle 10, which the camera 116B, C is showing to assist the driver in quickly recognizing which side of the vehicle 10 is being displayed on the inset area 122. Alternatively the entire display screen 114 may be switched to show the view of the appropriate “blind spot” when the turn indicator is used. The view on the display screen 114 or the inset area 122 may return to the previously displayed view after completion of the turn or after a predetermined amount of time.

The ECU 118 may also serve to highlight features on the display screen 114 as well. For example, emergency vehicles, motorcycles that may be difficult to see, or a missed turn, if a navigation system has been programmed. The highlighting of an object on the display screen 114 may be accomplished by brightening that portion of the display or circling or outlining the object in a highlighting color.

The ECU 118 may also change the display on the display screen 114 at the request of the driver. Controls for selecting between the different viewing modes 126, 128, 130 may be located on the steering wheel or instrument panel at a convenient location for the driver. The driver may select default settings for the ECU 118 to control the display screen 114 so that the display screen 114 operates in the desired manner while the vehicle 110 is moving without requiring input from the driver of the vehicle 110. A default display mode 126, 128,130 for the display screen 114 may also be chosen such that alternate displays will return to the default display mode 126, 128,130 after a predetermined period of time. A default display mode 126, 128,130 for the display screen 114 may also be chosen such that alternate display modes 126, 128,130 will return to the default display mode 126, 128,130 after a predetermined period of time.

Rear view mirrors are easily adjustable because the reflection perceived by a driver in a rear view mirror depends highly on the position of the mirror relative to the driver's head. Because cameras 116A-C are used there is an image on the display screen 114 rather than a reflection in a mirror. Thus, the need for the driver to adjust the display screen 114 to obtain the proper position for seeing the rear view of the vehicle 110 may be reduced or eliminated. However, the position of the display screen 114 may still be adjustable to enhance the individual driver's view of the display screen 114. In one embodiment the ECU 118 may recognize the desired display system 112 settings and position for an individual driver and adjust the display screen 114 and cameras 16A-C viewing mode 126, 128, 130 accordingly.

The cameras 116A-C may also be used by other vehicle 110 systems, such as vehicle 110 backing systems. Additional features 120 such as sensors or cameras for other systems may be connected to the ECU 118 as well to send information that may be displayed or used to display the image 124 on the display screen 114. The additional features may also include controls for driver adjustment of the cameras 116A-C, the display screen 114 and the images shown thereon.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A display system for a vehicle comprising:
a display screen mounted within a passenger compartment of a vehicle such that the display screen is visible to an driver of the vehicle;
at least one camera mounted to the vehicle and facing at least partially in a rear direction;
an ECU controllably connected to the display screen and the at least one camera to provide an image from the at least one camera on the display screen, wherein the display screen is used to provide an unobstructed image of a rear view from the vehicle from one of a plurality of viewing angles.

2. The display system of claim 1, wherein the at least one camera is controlled by the ECU to provide a plurality of different viewing angles.

3. The display system of claim 2, wherein the ECU controls the camera to do one of rotate, zoom, and to record in one of a plurality of viewing modes.

4. The display system of claim 3, wherein the plurality of viewing modes is at least a normal view mode, a close-in view mode, and a wide-angle view.

5. The display system of claim 1, wherein the at least one camera is multiple cameras and the ECU is operable to determine which of the multiple cameras is used to provide the image based upon an operating condition of the vehicle.

6. The display system of claim 1, wherein the at least one camera is multiple cameras and the ECU is operable to change which of the multiple cameras is used to provide the image based upon a driver selection.

7. The display system of claim 1, wherein the image on the display screen is altered by the ECU based upon an analysis by the ECU of the image from the at least one camera.

8. The display system of claim 7, wherein the image on the display screen is altered by one of dimming a selected portion of the image and highlighting a selected portion of the image.

9. The display system of claim 1, wherein the image on the display screen is shown continuously while the vehicle is operating.

10. A method for providing a rear view image for a vehicle comprising:
recording a rear view of the vehicle with at least one camera that is at least partially facing in a rear direction;
providing an unobstructed image of a rear view from the vehicle on a display screen, such that the image is visible to an driver of the vehicle; and
controlling the at least one camera with the ECU to change the image displayed on the display screen.

11. The method of claim 10, wherein controlling the at least one camera with the ECU further comprises changing one of the viewing angles and the viewing mode.

12. The method of claim 11, wherein the ECU selects the one of a viewing angle, and viewing mode from the unobstructed image based upon a current operation of the vehicle.

13. The method of claim 11, wherein the ECU selects the one of a viewing angle, and viewing mode from the unobstructed image based upon an input from the driver.

14. The method of claim 10, wherein controlling the at least one camera with the ECU further comprises changing the image provided from the at least one camera to a second camera.

15. The method claim 10, wherein changing the image is changing one of a portion of the image and a feature in the image.

16. The method of claim 10, wherein an unobstructed image on the display screen is provided continuously while the vehicle is operating.

17. The method of claim 10, further comprising:
analyzing the image from the at least one camera with the ECU; and
altering the image from the camera based upon the analysis of the image by the ECU.

18. A method for providing a rear view image for a vehicle comprising:
recording a rear view of the vehicle with at least one camera that is at least partially facing in a rear direction;
providing an unobstructed image of a rear view from the vehicle on a display monitor, such that the image is visible to an driver of the vehicle;
analyzing the image from the at least one camera with the ECU; and
altering the image from the camera based upon the analysis of the image by the ECU.

19. The method of claim 18, further comprising controlling the at least one camera with the ECU to change one of the viewing angles and the viewing mode.

20. The method of claim 19, wherein the ECU selects the one of a viewing angle, and viewing mode from the unobstructed image based upon one of a current operation of the vehicle and an input from the driver.

21. The method of claim 18, wherein an unobstructed image on the display screen is provided continuously while the vehicle is operating.
